(19) United States
(12) Patent Application Publication
(10) Pub. No.: US 2016/0288307 A1
(43) Pub. Date: Oct. 6, 2016

(54) Automatic Air Inrtake Device for Pneumatic Tool

(71) Applicant: Jhih Jhong Lin, Wujie Township (TW)

(72) Inventor: Jhih Jhong Lin, Wujie Township (TW)

(21) Appl. No.: 14/672,645

(22) Filed: Mar. 30, 2015

(51) Int. Cl. B25D 9/16; B25D 17/24

(52) U.S. Cl. CPC B25D 9/16; B25D 17/24

(57) ABSTRACT

An automatic air intake device for a pneumatic tool, and the pneumatic tool contains: a front segment, a rear segment, a body, a cylinder, a valve unit, a piston member, an elastic member, and automatic air intake device. The body includes a grip, a fitting sleeve, and an air passage; the fitting sleeve has a chamber, a closing face, an opening, and a notch. The cylinder is slidably fitted in the chamber and includes a room and a contacting fence. The valve unit is fixed between the room and the contacting fence, and the piston member is accommodated in the room and is pushed by high pressure air to move forward and backward. The elastic mechanism is fixed in the fitting sleeve and pushes the cylinder to move forward. The automatic air intake device includes a control shaft which has a close section and a guiding section.

### BACKGROUND OF THE INVENTION

The present invention relates to a pneumatic tool, and more particularly to an automatic air intake device for a pneumatic tool.

### Description of the Prior Art

A conventional pneumatic tool is driven by high pressure air which is used as a power source. With reference to FIGS. 9 and 10, the conventional pneumatic tool contains: a grip 10, a valve unit 20, a cylinder 30, and a piston member 40. The grip 10 includes an air inlet segment 101 connected with the high pressure air, an air passage 102 communicating with the air inlet segment 101, a trigger 103 for controlling the high pressure air to flow into the air inlet segment 101, and a cylindrical portion 104. The cylindrical portion 104 has a chamber 105 defined therein and communicating with the air passage 102. The valve unit 20 is mounted in the chamber 105 of the cylindrical portion 104, and one end of the cylinder 30 is inserted into the chamber 105 of the cylindrical portion 104, such that the cylinder 30 contacts with the valve unit 20. The cylinder 30 includes a room 301 defined therein and a flowing channel 302 formed between a front end of the room 301 and the valve unit 20, wherein the flowing channel 302 is in communication with the front end of the room 301 and the valve unit 20, and the piston member 40 is accommodated and slides in the room 301 of the cylinder 30. As the grip 10 is held by user's one hand, and the trigger 103 of the grip 10 is pressed or is grasped by the user's forefinger, the high pressure air flows into the valve unit 20 in the chamber 105 of the cylindrical portion 104 from the air inlet segment 101 of the grip 10 via the air passage 102, and the valve unit 20 controls the high pressure air to flow into the room 301 of the cylinder 30 and to push the piston member 40 toward a predetermined position, such that a tool head (not shown) is hit by the piston member 40, and the tool head stops the piston member 40, thereafter the valve unit 20 controls the high pressure air to flow into a front end of the room 301 of the cylinder 30 through the flowing channel 302, such that the piston member 40 is pushed by the high pressure air to slide backward to impact the valve unit 20, hence the piston member 40 is stopped by the valve unit 20, thus moving the piston member 40 to operate the pneumatic tool.

However, the user has to hold the grip 10 of the conventional pneumatic tool with one hand and to press or grasp the trigger 103 of the grip 10 with the forefinger, thus causing operational inconvenience and fatigue after a period of using time.

The present invention has arisen to mitigate and/or obviate the afore-described disadvantages.

### SUMMARY OF THE INVENTION

The primary objective of the present invention is to provide an automatic air intake device for a pneumatic tool which pushes or does not push an operating position to start or stop high pressure air, and a trigger is eliminated from the pneumatic tool, such that the pneumatic tool is operated easily to avoid pressing or grasping the trigger and operational fatigue.

To obtain above-mentioned objective, an automatic air intake device for a pneumatic tool provided by the present invention, wherein the pneumatic tool contains: a front segment, a rear segment, a body, a cylinder, a valve unit, a piston member, an elastic member, and automatic air intake device.

The body includes a grip, a fitting sleeve fitted with the grip, and an air passage for flowing high pressure air. The fitting sleeve has a chamber defined therein, a closing face formed on a first end thereof, an opening formed on a second end thereof, and a notch defined on a central position of the closing face.

The cylinder is slidably fitted, moves in the chamber of the fitting sleeve, and partially extends out of the fitting sleeve from the opening of the chamber. The cylinder includes a room defined therein and a contacting fence defined on one end thereof adjacent to the closing face of the chamber of the fitting sleeve.

The valve unit is fixed between the room of the cylinder and the contacting fence, such that the high pressure air is controlled by the valve unit to flow.

The piston member is accommodated in the room of the cylinder and is pushed by the high pressure air to slide forward and backward.

The elastic mechanism has elastic push force and is fixed in the fitting sleeve. The elastic mechanism pushes the cylinder to move forward.

The automatic air intake device includes a control shaft tightly fitted in then notch of the body and moves forward and backward with the cylinder, the control shaft has a close section and a guiding section, wherein when the close section of the control shaft stops the air passage of the body, the pneumatic tool is closed, and when the pneumatic tool moves forward to drive the cylinder to move backward, at least one portion of the guiding section of the control shaft aligns with the air passage, such that the high pressure passage flows in the air passage of the body smoothly, and the valve unit controls the high pressure air to push the piston member forward and backward.

### BRIEF DESCRIPTION OF THE DRAWINGS

FIG. 1 is a perspective view showing the assembly of a pneumatic tool according to a preferred embodiment of the present invention.

FIG. 2 is a perspective view showing the exploded components of the pneumatic tool according to the preferred embodiment of the present invention.

FIG. 3 is a cross sectional view showing the assembly of the pneumatic tool according to the preferred embodiment of the present invention.

FIG. 4 is a cross sectional view taken along the line A-A of FIG. 3.

FIG. 5 is an amplified plan view showing of a portion Al of FIG. 3.

FIG. 6 is a cross sectional view showing the operation of a piston member of the pneumatic tool according to the preferred embodiment of the present invention.

FIG. 7 is an amplified plan view showing of a portion A2 of FIG. 6.

FIG. 8 is another cross sectional view showing the operation of the piston member of the pneumatic tool according to the preferred embodiment of the present invention.

FIG. 9 is a cross sectional view showing the assembly of a conventional pneumatic tool.

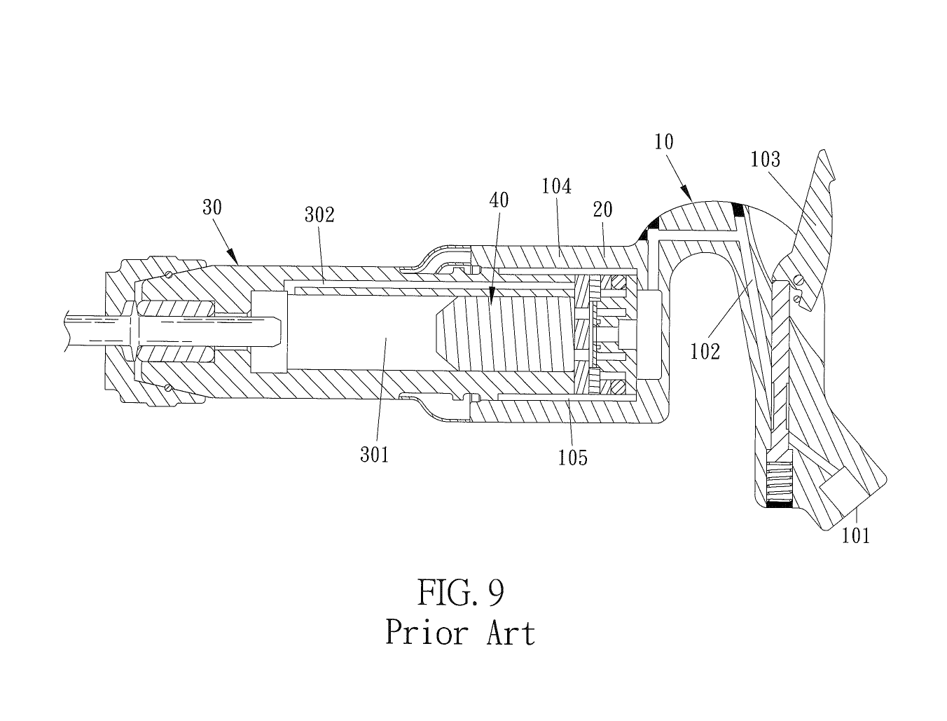

FIG. 10 is a cross sectional view showing the operation of the conventional pneumatic tool.

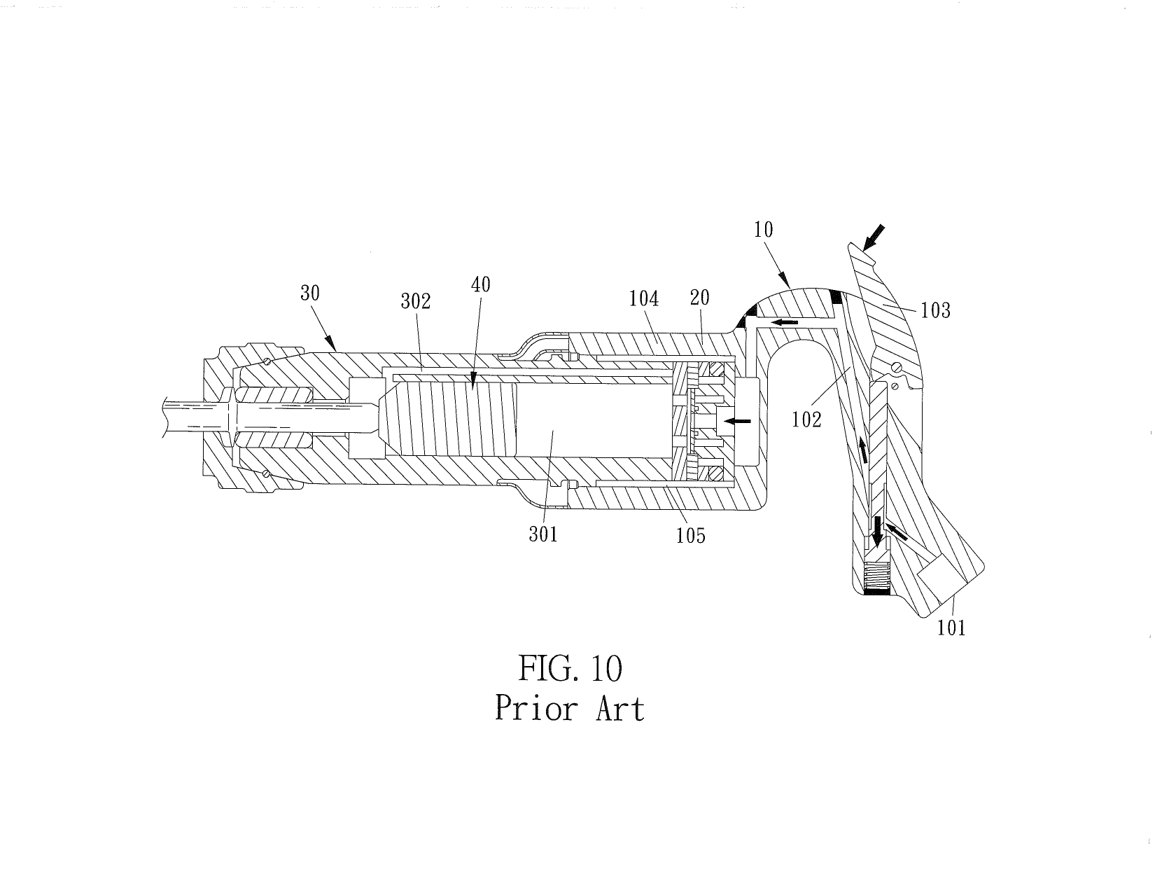

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

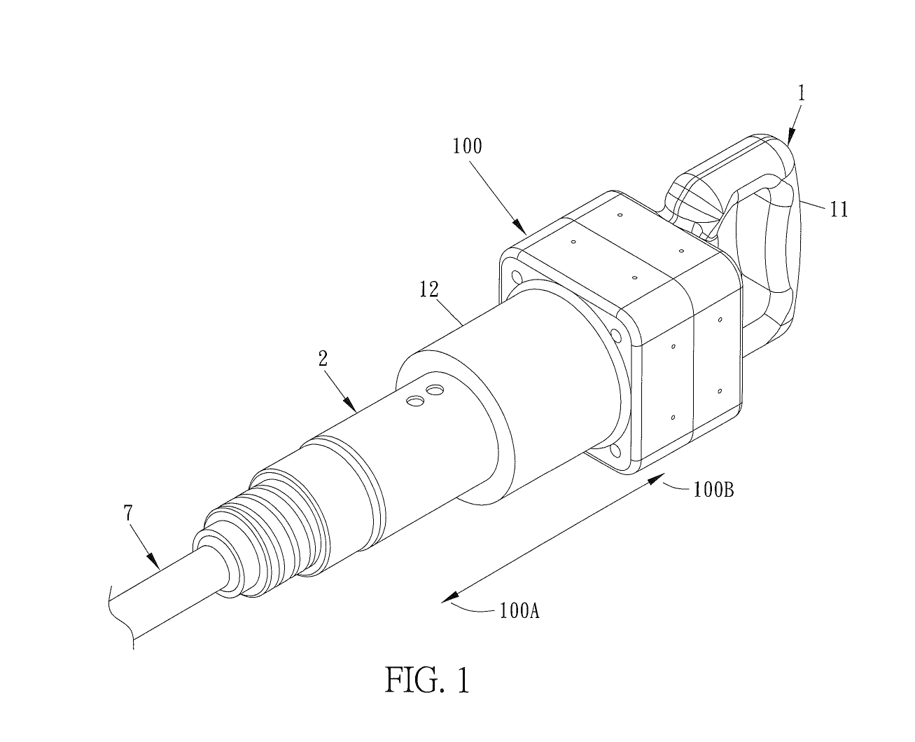

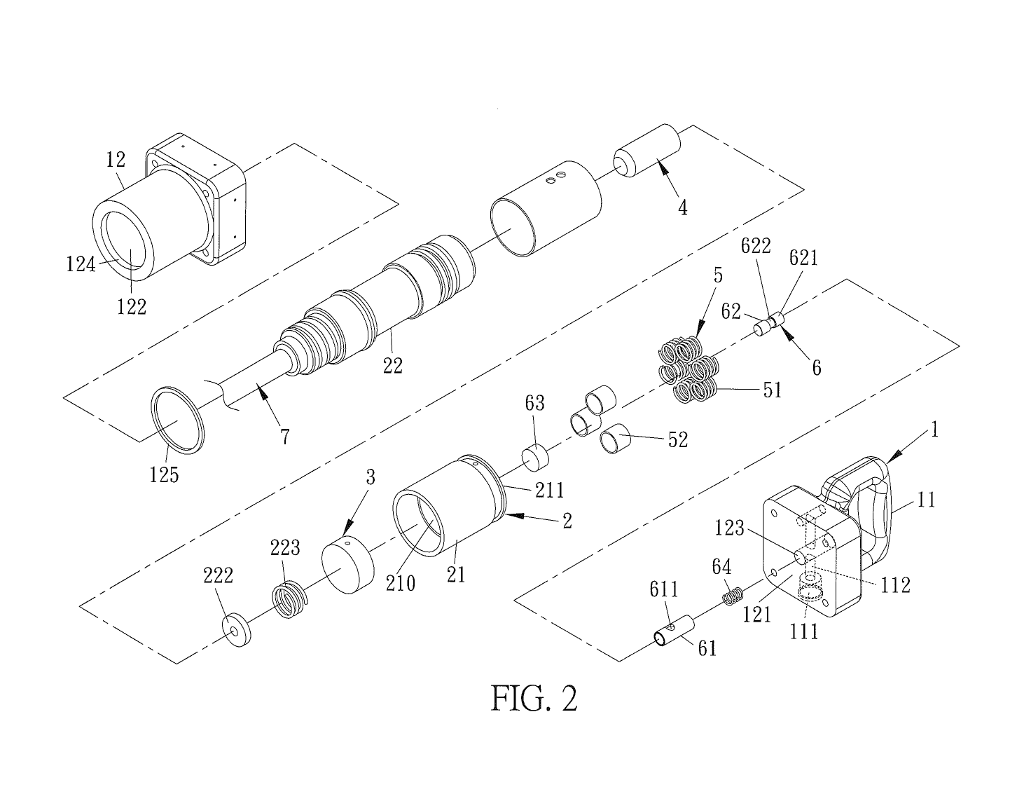

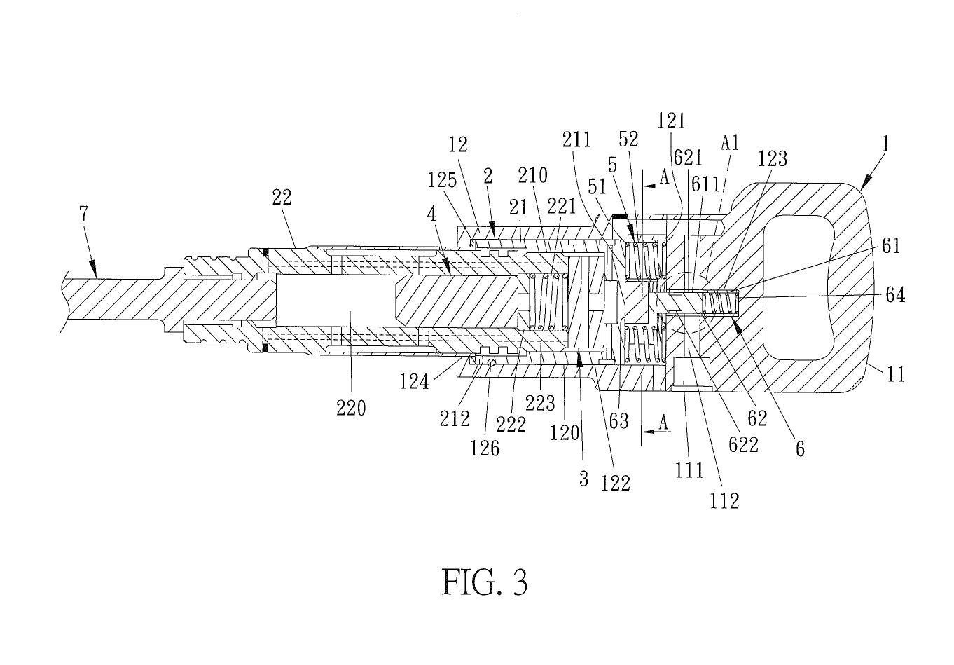

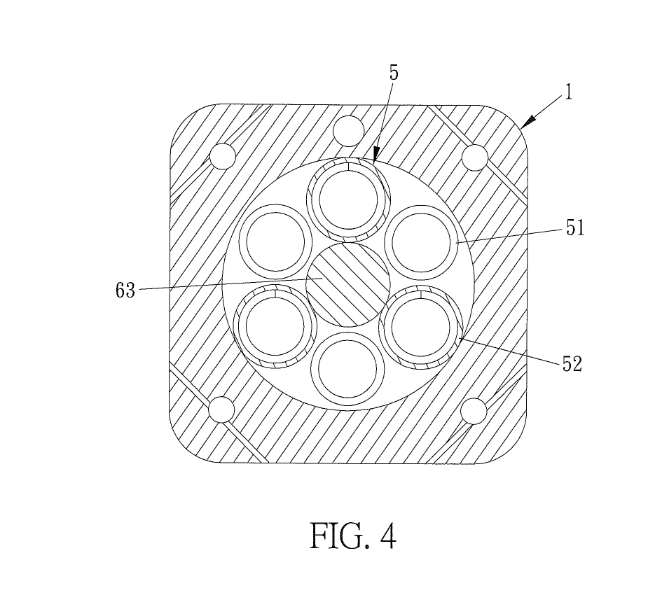

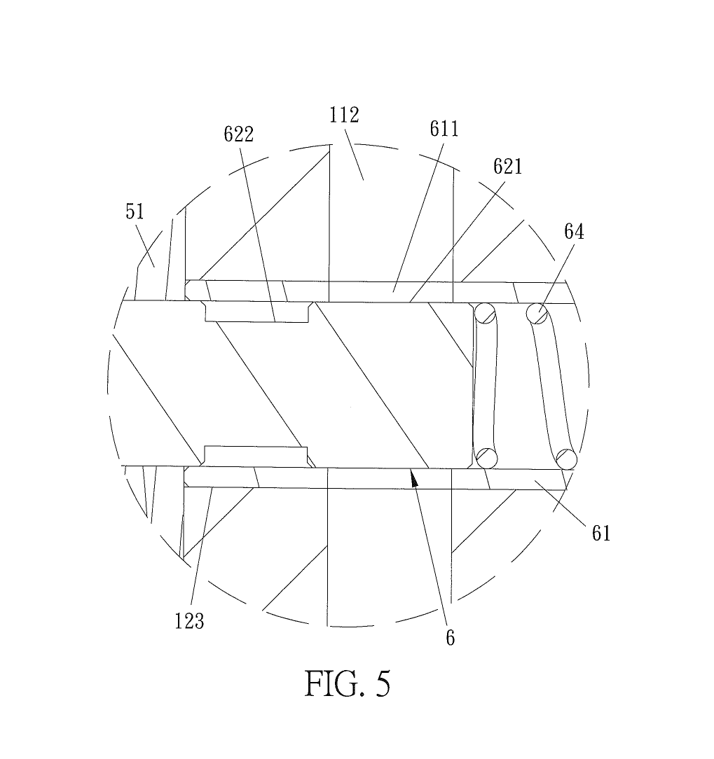

With reference to FIGS. 1 to 5, an automatic air intake device for a pneumatic tool according to a preferred embodiment of the present invention, wherein the pneumatic tool 100 comprises: a body 1, a cylinder 2, a valve unit 3, a piston member 4, an elastic mechanism 5, and an automatic air intake device 6. The body 1 includes a grip 11 and a fitting sleeve 12 fitted with the grip 11, the grip 11 has an air inlet segment 111 and an air passage 112 communicating with the air inlet segment 111; the fitting sleeve 12 has a chamber 120 defined therein, a closing face 121 formed on a first end thereof, an opening 122 formed on a second end thereof, a notch 123 defined on a central position of the closing face 121 and being perpendicular to the air passage 112, and a stop rib 124 extending inwardly from an inner side of the opening 122. The cylinder 2 is comprised of a slidable sleeve 21 and a tubular member 22, wherein the slidable sleeve 21 is slidably fitted and moves in the chamber 120 of the fitting sleeve 12, the slidable sleeve 21 has a hollowing portion 210 formed therein, and a contacting fence 211 is defined on one end of the hollow portion 210 adjacent to the closing face 121 of the chamber 120 of the fitting sleeve 12, the slidable sleeve 21 is stopped by a washer 125 for matching with the stop rib 124 of the fitting sleeve 12, and the slidable sleeve 21 has a limiting slot 212 defined on an outer side thereof to insert a defining element 126 of the fitting sleeve 12, wherein a first end of the tubular member 22 is inserted into the hollow portion 210 of the slidable sleeve 21 to connect with the slidable sleeve 21 in a screwing manner, such that the tubular member 22 and the slidable sleeve 21 move forward and backward in the chamber 120 of the fitting sleeve 12. Furthermore, a second end of the tubular member 22 partially extends out of the fitting sleeve 12 from the opening 122 of the chamber 120 of the fitting sleeve 12 to couple with a tool head 7, the tubular member 22 has a room 220 defined therein and a diameter increasing groove 221 formed on a rear end of the room 220 to accommodate a circular moving member 222 and a compression spring 223. The valve unit 3 is fixed between the room 20 of the cylinder 2 and the contacting fence 211, such that the high pressure air flows toward the valve unit 3 through the air passage 112 of the grip 11, and then the valve unit 3 controls a flowing direction of the high pressure air (the valve unit 3 is a well-known art, its further remarks are omitted). The piston member 4 is accommodated in the room 220 of the tubular member 22 and is pushed by the high pressure air to slide forward and backward. The elastic mechanism 5 includes a plurality of push springs 51 and plural positioning sheaths 52, wherein the plurality of push springs 51 are fixed in the chamber 120 of the fitting sleeve 12, and the plural positioning sheaths 52 fix the plurality of push springs 51 separately, such that the plurality of push springs 51 are biased against the closing face 121 of the chamber 120 of the fitting sleeve 12 and the contacting fence 211 of the slidable sleeve 21 of the cylinder 2, and the plurality of push springs 51 push the cylinder 2 on a front segment 100A. The automatic air intake device 6 includes a leakproof tube 61 and a control shaft 62, wherein the leakproof tube 61 is fitted in the notch 123 of the body 1 and has a through orifice 611 formed on a peripheral side thereof and communicating with the air passage 112 of the body 1, the control shaft 62 is tightly fitted in the leakproof tube 61, wherein a first end of the control shaft 62 indirectly contacts with the contacting fence 211 of the cylinder 2 by using a flexible block 63 or directly contacts with the contacting fence 211 of the cylinder 2, and between a second end of the control shaft 62 and a bottom end of the notch 123 of the body 1 is fitted a resilient element 64, wherein the control shaft 62 has a close section 621 and a guiding section 622, when the tool head 7 is in connection with the cylinder 2 and does not push an operating position, the control shaft 62 is pushed by the resilient element 64 to move on the front segment 100A, such that the close section 621 of the control shaft 62 aligns with the through orifice 611 of the leakproof tube 61 to stop the air passage 112 of the body 1, thus closing the pneumatic tool 100.

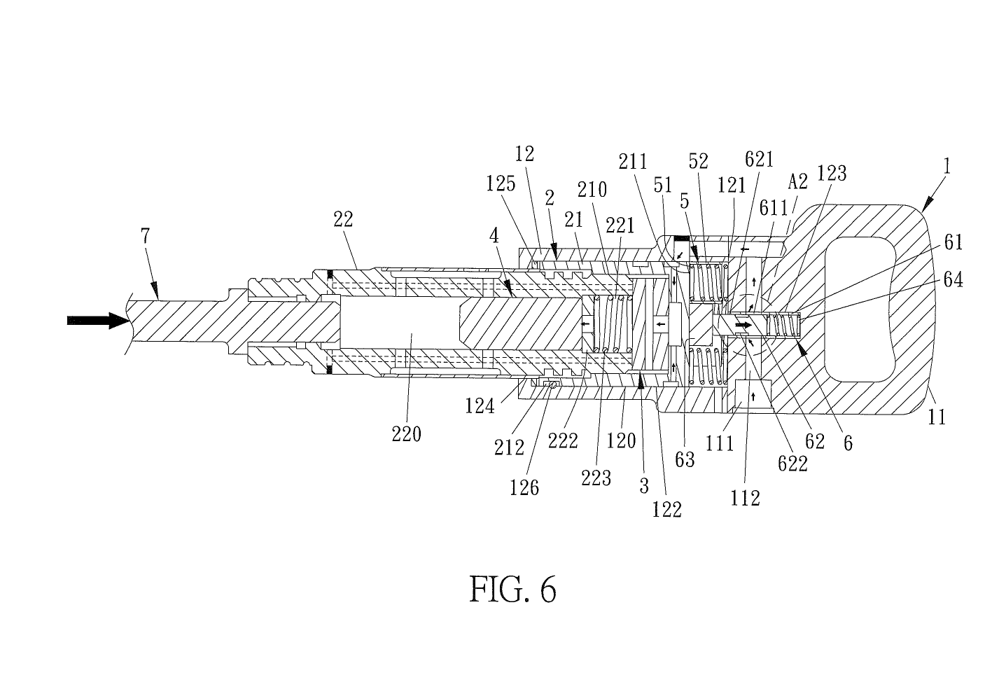

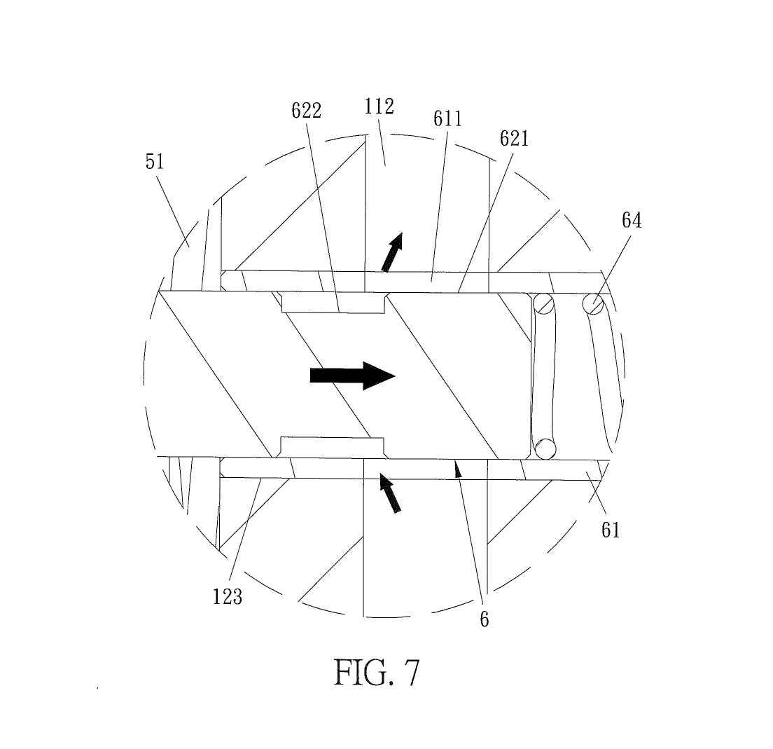

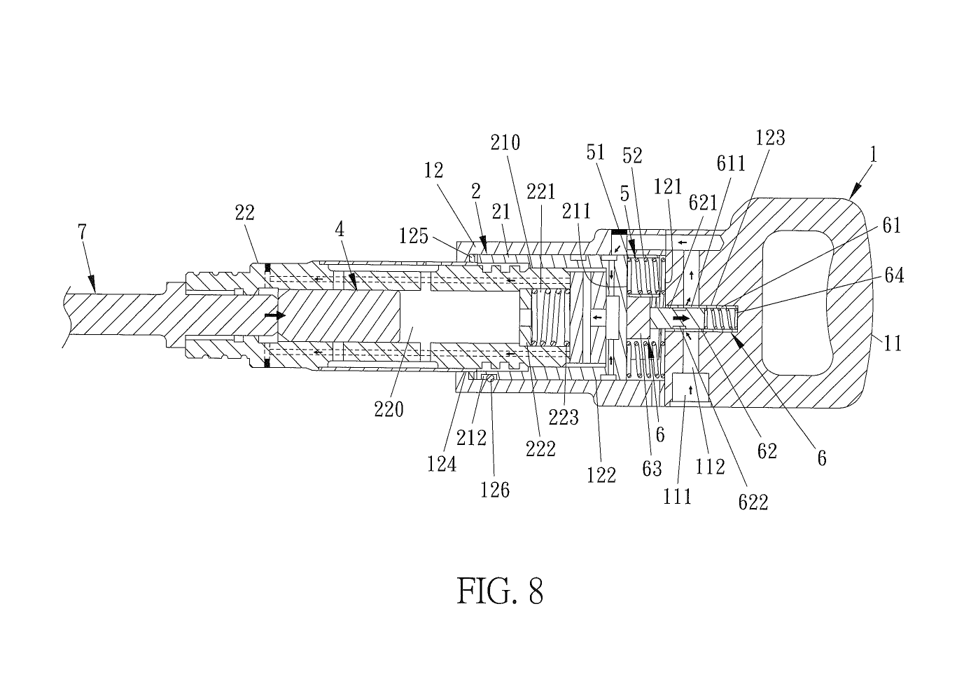

Thereby, when the cylinder 2 and the tool head 7 move on the front segment 100A to push the operating position, the cylinder 2 presses by ways of the elastic mechanism 5 and moves backward in the chamber 123 of the fitting sleeve 12 with the slidable sleeve 21 on a rear segment 100B, as shown in FIGS. 6 and 7, and the control shaft 62 of the automatic air intake device 6 is pushed by the contacting fence 211 of the slidable sleeve 21 of the cylinder 2 on the rear segment 100B to push the compression spring 64, hence at least one portion of the guiding section 622 of the control shaft 62 is in alignment with and the through orifice 611 of the leakproof tube 51 and the air passage 112 of the body 1 to flow the high pressure air smoothly in the air passage 112 of the body 1, such that the high pressure air is fed automatically to flow toward the valve unit 3 via the air passage 112 of the grip 11, and then the high pressure air is controlled by the valve unit 3 to flow toward the rear end of the room 220 of the tubular member 22, thereafter the piston member 4 is pushed by the high pressure air to slide toward a front end of the room 220 on the front segment 100A so as to hit the tool head 7, and the tool head 7 stops the piston member 4. As illustrated in FIG. 8, the high pressure air is controlled by the valve unit 3 to flow into the front end of the room 220 of the cylinder 2 and to push the piston member 4, hence the piston member 4 is pushed by the high pressure air to move toward the rear end of the room 220 on the rear segment 1006 so as to impact the valve unit 3 via the circular moving member 222 and the compression spring 223, thus pushing the piston member 4 forward and backward.

When the cylinder 2 and the tool head 7 move away from the operating position, the control shaft 62 is pushed by the compression spring 64 to move back to an original position on the front segment 100A, such that the close section 621 of the control shaft 62 aligns with the through orifice 611 of the leakproof tube 61 to stop the air passage 112 of the body 1, thus closing the pneumatic tool 100 automatically.

Preferably, the automatic air intake device 6 does not provide with. the resilient element 64, and the control shaft 62 is connected with the slidable sleeve 21 of the cylinder 2, such that when the cylinder 2 and the tool head 7 move away from the operating position, the slidable sleeve 21 of the cylinder 2 drives the control shaft 62 to move on the front segment 100A, hence the close section 621 of the control shaft 62 aligns with the through orifice 611 of the leakproof tube 61 to stop the air passage 112 of the body 1, thus closing the pneumatic tool 100 automatically.

Thereby, the automatic air intake device of the present invention has advantages as follows:

the cylinder 2 and the tool head 7 of the automatic air intake device push or do not push the operating position to open or close the high pressure air automatically, thus enhancing using convenience. In addition, the body 1 does not include the trigger, so as desiring to feed the high pressure air, a user does not press or grasp with his/her fingers, thus avoiding operational fatigue after a period of using time.

While various embodiments in accordance with the present invention have been shown and described, it is clear to those skilled in the art that further embodiments may be made without departing from the scope of the present invention.

What is claimed is:

1. An automatic air intake device for a pneumatic tool, and the pneumatic tool comprising: a front segment, a rear segment, and
a body including a grip, a fitting sleeve fitted with the grip, and an air passage for flowing high pressure air, the fitting sleeve having a chamber defined therein, a closing face formed on a first end thereof, an opening formed on a second end thereof, and a notch defined on a central position of the closing face;
a cylinder slidably fitted, moving in the chamber of the fitting sleeve, and partially extending out of the fitting sleeve from the opening of the chamber, the cylinder including a room defined therein and a contacting fence defined on one end thereof adjacent to the closing face of the chamber of the fitting sleeve;
a valve unit fixed between the room of the cylinder and the contacting fence, such that the high pressure air is controlled by the valve unit to flow;
a piston member accommodated in the room of the cylinder and pushed by the high pressure air to slide forward and backward;
an elastic mechanism having elastic push force and fixed in the fitting sleeve, the elastic mechanism pushing the cylinder to move forward;
an automatic air intake device including a control shaft tightly fitted in then notch of the body and moving forward and backward with the cylinder, the control shaft having a close section and a guiding section, wherein when the close section of the control shaft stops the air passage of the body, the pneumatic tool is closed, and when the pneumatic tool moves forward to drive the cylinder to move backward, at least one portion of the guiding section of the control shaft aligns with the air passage, such that the high pressure passage flows in the air passage of the body smoothly, and the valve unit controls the high pressure air to push the piston member forward and backward.

2. The automatic air intake device for the pneumatic tool as claimed in claim 1, wherein the notch of the body is perpendicular to the air passage.

3. The automatic air intake device for the pneumatic tool as claimed in claim 1, wherein the opening of the chamber of the fitting sleeve has a stop rib extending inwardly from an inner side thereof, and the cylinder is stopped by a washer for matching with the stop rib of the fitting sleeve.

4. The automatic air intake device for the pneumatic tool as claimed in claim 1, wherein the cylinder is comprised of a slidable sleeve and a tubular member, the slidable sleeve is slidably fitted and moves in the chamber of the fitting sleeve, the slidable sleeve has a hollowing portion formed therein, and a contacting fence of the cylinder is defined on one end of the hollow portion adjacent to the closing face of the chamber of the fitting sleeve, one end of the tubular member is inserted into the hollow portion of the slidable sleeve to connect with the slidable sleeve in a screwing manner.

5. The automatic air intake device for the pneumatic tool as claimed in claim 4, wherein the slidable sleeve has a limiting slot defined on an outer side thereof to insert a defining element of the fitting sleeve.

6. The automatic air intake device for the pneumatic tool as claimed in claim 1, wherein the elastic mechanism includes a plurality of push springs and plural positioning sheaths, wherein the plurality of push springs are fixed in the chamber of the fitting sleeve, and the plural positioning sheaths fix the plurality of push springs separately, such that the plurality of push springs are biased against the closing face of the chamber of the fitting sleeve and the contacting fence of the slidable sleeve of the cylinder.

7. The automatic air intake device for the pneumatic tool as claimed in claim 1, wherein the automatic air intake device also includes a leakproof tube fitted in the notch of the body and has a through orifice formed on a peripheral side thereof and communicating with the air passage of the body, the control shaft is tightly fitted in the leakproof tube in the notch of the body.

8. The automatic air intake device for the pneumatic tool as claimed in claim 7, wherein a first end of the control shaft indirectly contacts with the contacting fence of the cylinder by using a flexible block or directly contacts with the contacting fence of the cylinder, and between a second end of the control shaft and a bottom end of the notch of the body is fitted a resilient element.
